(19) United States
(12) Patent Application Publication
(10) Pub. No.: US 2006/0095785 A1
(43) Pub. Date: May 4, 2006

(54) System, method, and computer program product for user password reset

(75) Inventor: John D. White JR., Sharpsville, IN (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 10/978,217

(22) Filed: Oct. 29, 2004

(51) Int. Cl. H04K 1/00

(52) U.S. Cl. 713/184

(57) ABSTRACT

A system, method, and computer program product utilizing a default user ID, such as “help,” that has no assigned password. When the user logs into the computer using this ID, their login is “captured” and a crippled windows manager is started along with a web browser pointed to a specific URL. The user has no ability to manipulate the operating system, the local file system, or even the web browser. All the user is able to do is interact with the automated reset page(s) on the network authentication server. Once the user has completed her password reset and closed the browser, the user's web session is logged out and the user can now log in with her new password and her original userid.

### TECHNICAL FIELD OF THE INVENTION

The present invention is directed, in general, to security and control methods for data processing systems and data processing system networks.

### BACKGROUND OF THE INVENTION

Currently, users who work on machines running either a UNIX or LINUX Operating System, who need to have their password reset, cannot access a website for automated password reset because they cannot log onto the computer without their correct password. A password reset might be required when a user has forgotten his current password, when a password has expired, when a password has been “locked” due to failed login attempts, or other common reasons. In these cases, the user is unable to access a system using their username/password until the password has been reset, typically including a separate authentication to ensure that the user is actually the individual that is entitle to access to the system. Similar problems exist for users of other common operating systems.

One common password reset technique is used in both commercial and non-commercial Internet transactions. Here, it is common that if a user has forgotten her password, she can request that the password be sent to her by electronic mail, or that she be permitted to otherwise identify herself in order to choose a new password. These cases, however, assume that the user is still able to use her computer system to perform these tasks, such as to check her email to receive the password reminder, and are useless if the user cannot operate the computer system at all until her password is reset, as when a typical system is first booted or has been “locked.” In these cases, the user must typically contact a technical support person to manually reset the password.

A large commercial entity may manage hundreds or even thousands of computers. Since, by some estimates, a full 60% of help-desk calls in large corporations are for password-reset requests, the manpower required to handle the password reset activities alone require a great deal of expense. There is, therefore, a need in the art for a system, method, and computer program product for user password reset.

### SUMMARY OF THE INVENTION

A preferred embodiment includes a system, method, and computer program product utilizing a default user ID, such as “help,” that has no assigned password. When the user logs into the computer using this ID, their login is “captured” and a crippled windows manager is started along with a web browser pointed to a specific URL. The user has no ability to manipulate the operating system, the local file system, or even the web browser. All the user is able to do is interact with the automated reset page(s) on the network authentication server. Once the user has completed her password reset and closed the browser, the user's web session is logged out and the user can now log in with her new password and her original userid.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a data processing system in which aspects of an embodiment of the present invention can be implemented;

FIG. 2 depicts a data processing system network in which an embodiment of the present invention can be implemented; and

FIG. 3 depicts a flowchart of a process in accordance with a preferred embodiment.

### DETAILED DESCRIPTION OF THE INVENTION

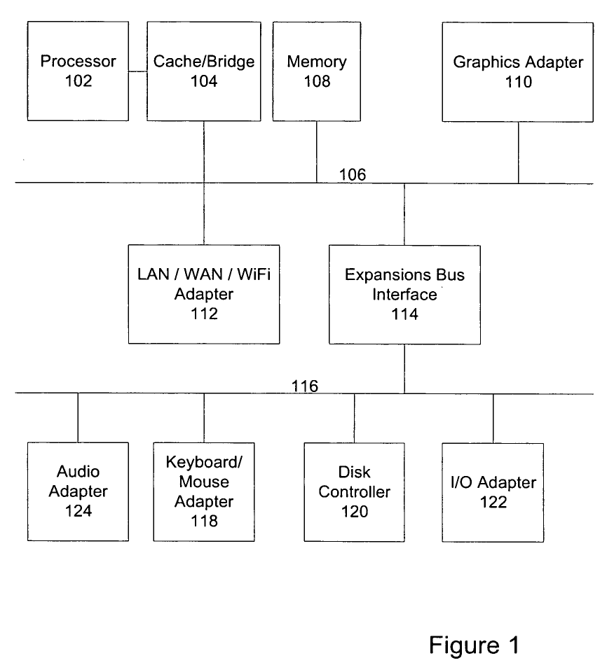

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as UNIX, LINUX, a version of Microsoft Windows™, or others may be employed if suitably modified. The operating system is modified or created in accordance with the present invention as described.

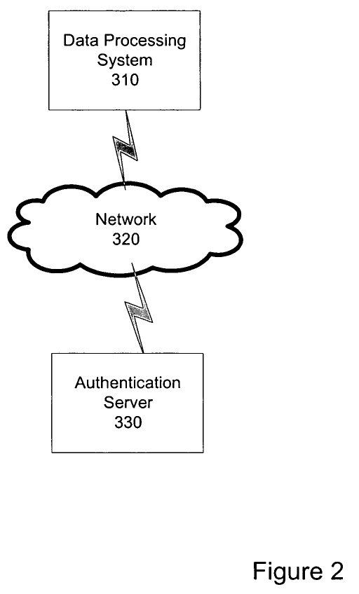

FIG. 2 depicts a simplified block diagram of a data processing system network in which an embodiment of the present invention can be implemented. Here, data processing system 210 is shown, configured to communicate with authentication server 230 via network 220. In practice, there typically will be many different data processing systems connected to network 220, including client and server systems. Network 220 can be an internal or external network, including the Internet, and can be comprised of multiple separate networks. Assumed here is that a user of data processing system 210, before gaining any substantial access to data processing system 210 or any other systems it is connected to, must first be authenticated by authentication server 230, typically using a username/password combination.

Authentication server 230 can be implemented using any number of known techniques and packages, such as Lightweight Directory Access Protocol (LDAP), MICROSOFT ACTIVE DIRECTORY, and others. The authentication server 230 also includes a user authentication and password-reset routine. In this routine, the user, identified by her userid, is authenticated by some means other than the password normally associated with the userid, e.g., by a challenge/response of other known data, by a biometric, or by other known means. Upon authenticating the user, the password-reset routine allows the user to reset her password or select a new password, which becomes valid for that userid.

A preferred embodiment includes a specific-purpose user ID called ‘help’ that has no assigned password; of course, any userid can be specified for this function. In alternate embodiments, this specific-purpose userid can include a required password, such as one that is well known, or a user identifier, or other password that is optionally logged, so long as the user is consistently able to access the specific-purpose userid. When the user logs into the computer using this ID, their login is “captured” and a crippled windows manager is started along with a web browser pointed to a specific URL. The user has no ability to manipulate the operating system, the local file system, or even the web browser. All the user is able to do is interact with the automated reset page(s) on the network authentication server. Once the user has completed her password reset and closed the browser, the user's web session is logged out and the user can now log in with her new password and her original userid/username.

In the specific examples below, a UNIX/LINUX operating system is used, but those of skill in the art will recognize that the same principles and techniques can be employed in a variety of operating systems, including the MICROSOFT WINDOWS family of operating systems. Further, specific examples below employ the MOZILLA web browser, but the teachings, modified in a manner familiar to those of skill in the art, can be applied to other web browsers, such as FIREFOX and INTERNET EXPLORER.

In the preferred embodiments, it is important that the user be able to logon to the system and network using a specific-purpose userid, in this case the “help” userid. When the user logs in to the data processing system using this userid (as opposed to his “normal” userid), the system will allow access only for the purpose of connecting with the authorization server, and permitting the user to do nothing but connect to the password-reset routine on the authorization server.

When the user has completed the password-reset routine, he is logged back out of the data processing system, and must re-log in using his normal userid and newly-reset password.

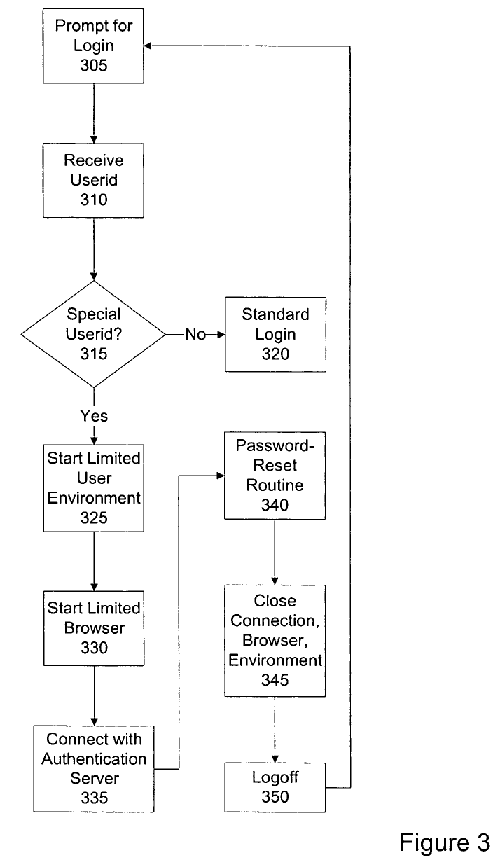

FIG. 3 depicts a flowchart of a process in accordance with a preferred embodiment, as performed by the local data processing system. Note that this process can be performed in a full data processing system, as shown in FIG. 1, or in a limited-function terminal system, so long as the system can communicate over the network.

Here, the system first prompts the user for a login (step 305), then receives a userid (step 310). Upon receiving the userid, the system determines if the userid is the specific-purpose password-reset userid (step 315), in this example, “help”. If not, the standard verification/login process is followed (step 320), whatever that may be.

If the “help” userid is entered, then the system will start a limited-function user environment (step 325), in which the user is preferably only able to reset his password. The system will then open a browser session (step 330), that can only connect with the specific network address and port of the authentication server (step 330). Note that while the preferred embodiment herein uses a commonly available commercial browser, with a “crippled” interface allowing only the password-reset interaction, other embodiments can include a custom interface capable only of communicating with the authentication server.

The system will connect with the authentication server (step 335), and allow the user to complete an appropriate authentication and password-reset routine (step 340), as known to those of skill in the art.

After the password-reset routine is completed (or aborted), the system will close the connection, browser, and limited-function user environment (step 345), and logoff the “help” user (step 350). The system then returns to its default user login prompt (at step 305).

Following are exemplary instructions for configuring a limited-function user environment, as described, using REDHAT LINUX v. 9 and the MOZILLA browser. Unless otherwise specified, the programmer performing the configuration must have “root” credentials on the data processing system operating system to perform each step:

First, create a user called “help” (or otherwise, as desired). Create a home directory and a password for the “help” user. Edit “/etc/shadow” and delete the encrypted password for the help user, which appears between the colon marks.

Next, use the “touch” command to create an empty file called “.mwmrc” in “/home/help/”. this eliminates the right-mouse menu options for the mwm windows manager which will prevent the user from right-mouse clicking on the desktop and launching a new xterm session.

Next, create a file called “userChrome.css” in “/home/help/.mozilla/default/?/chrome/”, where the ‘?’ represents a unique encrypted folder name for each installation. This file must contain the following entries which will remove the menus from the MOZILLA browser:
menu [label=“File”] {display: none; !important}
menu [label=“Edit”] {display: none; !important}
menu [label=“View”] {display: none; !important}
menu [label=“Go”] {display: none; !important}
menu [label=“Bookmarks”] {display: none; !important}
menu [label=“Tools”] {display: none; important}
menu [label=“Window”] {display: none; !important}
menu [label=“Help”] {display: none; !important}

Next, optionally, edit the file “/etc/X11/xdm/kdmrc”. Find the entry labeled “SessionTypes=” and add “help” to the list; this makes the option to run the “help” session type show up in the list of desktop environments listed on the login screen

Next, log in as the “help” user and launch the MOZILLA browser. Through the “View” menu, DESELECT all of the options in the “Show/Hide” submenu (e.g., Navigation Toolbar, Personal Toolbar, Status Bar, Component Bar, Sidebar). Also, make sure the “Site Navigation Bar” submenu is set to “Hide Always”.

Next, change the default directory to “/home/help/” and issue the following command “chmod 744 *” to ensure that no other user can log in under their own ID and alter the “help” user settings.

Next, edit the file “/etc/X11/xdm/Xsession” and find the section where the code determines which desktop environment was selected; which by default is prefaced with a comment that says, “# now, we see if xdm/gdm/kdm has asked for a specific environment”. This will force the “help” user to only log into the “help” desktop environment that has been created for the password-reset routine.

Add the following code segments:

Immediately preceding
case $# in
1)
   Put the following code. This forces the “help” user to use the “help” desktop environment and ONLY the “help” desktop environment. Without this, they could choose a different one on the login screen, so we are ensuring they only get the “help” DE.
if [$LOGNAME==“help”]; then DeskTopRequested=“help”
else DeskTopRequested=$1
fi

In the entire case statement starting with
case $1 in
failsafe)
exec -1 $SHELL -c “xterm -geometry 80×24-0-0”;;
   replace all of the $1 with $DeskTopRequested.

And add the “help” desktop environment case immediately following the “failsafe” case. The “-1” switch instructs the script to log in and the -c is the command to execute. The ‘mwm &’ launches a small footprint windows manager and the remainder of that command launches the MOZILLA browser with the specific password reset URL.
help)
exec -1 $SHELL -c “mwm & /usr/lib/mozilla-1.2.1/mozilla-bin -height 600 -width 800 [full network address/URL for authentication server and password-reset routine]”
;;

The full network address/URL for authentication server and password-reset routine should be inserted in the line above. Of course, similar modifications and customizations can be made, within the abilities of one skilled in the art, to other operating systems and browsers.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

What is claimed is:

1. A method for user password reset, comprising:
prompting a user for a userid input in a data processing system;
receiving a userid;
if the userid is a specific-purpose userid, then
starting a limited user environment in the data processing system;
starting a limited-function user interface in the limited user environment;
connecting, over a network, to an authentication server; and
allowing a user to complete a password-reset routine with the authentication server.

2. The method of claim 1, further comprising closing the limited-function user interface and closing the limited user environment.

3. The method of claim 1, wherein the limited user environment only allows operation of the limited-function user interface and connection to the authentication server.

4. The method of claim 1, wherein the limited-function user interface only allows connection to the authentication server and completion of the password-reset routine.

5. The method of claim 1, wherein the specific-purpose userid does not require a password.

6. The method of claim 1, wherein the limited-user environment only allows connection to the authentication server at a specific network address.

7. The method of claim 1, wherein if the userid is not a specific-purpose userid, then a standard login routine is performed.

8. A data processing system having at least a processor and accessible memory, comprising:
means for prompting a user for a userid input in a data processing system;
means for receiving a userid;
means for, if the userid is a specific-purpose userid,
starting a limited user environment in the data processing system;
starting a limited-function user interface in the limited user environment;
connecting, over a network, to an authentication server; and
allowing a user to complete a password-reset routine with the authentication server.

9. The data processing system of claim 8, further comprising means for closing the limited-function user interface and closing the limited user environment.

10. The data processing system of claim 8, wherein the limited user environment only allows operation of the limited-function user interface and connection to the authentication server.

11. The data processing system of claim 8, wherein the limited-function user interface only allows connection to the authentication server and completion of the password-reset routine.

12. The data processing system of claim 8, wherein the specific-purpose userid does not require a password.

13. The data processing system of claim 8, wherein the limited-user environment only allows connection to the authentication server at a specific network address.

14. The data processing system of claim 8, wherein if the userid is not a specific-purpose userid, then a standard login routine is performed.

15. A computer program product tangibly embodied in a machine-readable medium, comprising:
instructions for prompting a user for a userid input in a data processing system;
instructions for receiving a userid;
instructions for, if the userid is a specific-purpose userid, then
starting a limited user environment in the data processing system;
starting a limited-function user interface in the limited user environment;
connecting, over a network, to an authentication server; and
allowing a user to complete a password-reset routine with the authentication server.

16. The computer program product of claim 15, further comprising instructions for closing the limited-function user interface and closing the limited user environment.

17. The computer program product of claim 15, wherein the limited user environment only allows operation of the limited-function user interface and connection to the authentication server.

18. The computer program product of claim 15, wherein the limited-function user interface only allows connection to the authentication server and completion of the password-reset routine.

19. The computer program product of claim 15, wherein the specific-purpose userid does not require a password.

20. The computer program product of claim 15, wherein the limited-user environment only allows connection to the authentication server at a specific network address.

21. The computer program product of claim 15, wherein if the userid is not a specific-purpose userid, then a standard login routine is performed.
